(19) United States
(12) Patent Application Publication
(10) Pub. No.: US 2009/0045174 A1
(43) Pub. Date: Feb. 19, 2009

(54) Device for exchanging a nozzle of a vapor plasma burner and nozzle and guard ring

(76) Inventors: Wolfgang Haberler, Scharnstein (AT); Harald Langeder, Pettenbach (AT); Heribert Pauser, Grafenworth (AT)

Correspondence Address: COLLARD & ROE, P.C., 1077 NORTHERN BOULEVARD, ROSLYN, NY, 11576, US

(21) Appl. No.: 11/990,790

(22) PCT Filed: Sep. 5, 2006
(86) PCT No.: PCT/AT2006/000363

§ 371 Date: Feb. 21, 2008

(30) Foreign Application Priority Data
Sep. 9, 2005 (AT) A 1483/2005

(51) Int. Cl. H05H 1/34; B23K 9/29; B23K 10/02

(52) U.S. Cl. 219/121.5; 219/121.52

(57) ABSTRACT

The invention relates to a device for exchanging a nozzle (21) of a vapor plasma burner (6), comprising a housing, a cathode (38) connected to a cathode support, and an anode, configured as a nozzle (31) and having an exit opening (22). The nozzle (21) can be connected to a base (69) of the vapor plasma burner (6). An insulating protective cap (23) is disposed in the area of the exit opening (22). The protective cap (23) can be detached via a spring element (66) and is rotationally secured to the base (69) of the vapor plasma burner (6). The protective cap (23), at its front, has a recess (24) which corresponds to the nozzle (21) and into which the nozzle (21) can be inserted. The nozzle (21) can be detached from or secured to the base (69) without the use of auxiliary means by displacing the protective cap (23).

The present invention relates to a device for exchanging a nozzle of a vapor plasma burner, a nozzle, and a guard ring for a vapor plasma burner as described in the preambles of claims 1, 10, and 16.

Devices for exchanging a nozzle of a plasma welding torch are known from prior art, wherein the nozzle must be detached from the plasma welding torch by a twisting movement, as known from AT 411 972 B. According to this document, the nozzle is mounted on the plasma welding torch by means of a screw connection, i.e. a thread. In order to exchange the nozzle, it is necessary to first remove the gas nozzle, then the nozzle may be screwed out. This is done using a special tool, because the nozzle is hot after welding or cutting.

Disadvantageously, two process steps are necessary to exchange the nozzle, because the gas nozzle has to be removed first. In addition, appropriate protective measures have to be taken, because particularly the parts around the nozzle of the plasma welding torch are hot after welding or cutting.

The object of the present invention is to allow exchange of the nozzle as simply as possible, avoiding the disadvantages of prior art.

The object of the present invention is achieved by providing an insulating protective cap in the area of the exit opening of the nozzle, said protective cap being detachable via a spring element and being rotationally secured to the base of said vapor plasma burner. In addition, said protective cap has at its front a recess corresponding to said nozzle into which said nozzle may be inserted, and said nozzle may be detached from or secured to said base without the use of auxiliary means by moving said protective cap.

Advantageously, exchange of the nozzle may be effected without any additional auxiliary means. Moreover, said exchange is independent of the position of the vapor plasma burner or the nozzle and may be effected at any time. Thus, the time required to exchange the nozzle is shorter, of course.

As that the protective cap remains on the burner when exchanging the nozzle, advantageously only the new nozzle has to be inserted into the protective cap. This considerably reduces the time required for such exchange.

Moreover, the object of the present invention is achieved by providing a driver area between the mounting area and the preferably conical area, said driver area being of such a shape that said nozzle may be received in said protective cap of said vapor plasma burner positively and distortion-proof to secure said nozzle to said vapor plasma burner.

Advantageously, said nozzle is equipped with a driver area allowing exchange of said nozzle without any auxiliary means.

Advantageously, the fact that said driver area is shaped distortion-proof allows the nozzle to be received by the protective cap in a number of positions.

It is also advantageous that a projection protects the driver area, the corresponding recess in the protective cap, and the mounting area from being soiled by the cutting process.

Furthermore, the object of the present invention is achieved by one front surface of the guard ring being equipped with at least one mounting device for detachable attachment to a protective cap, and said guard ring being provided with a recess configured to receive and envelop a nozzle when mounted on a protective cap.

Advantageously, said nozzle, particularly said projection, is enveloped, thus increasing the effect of protection from soiling. This ensures effective protection of the driver area, the corresponding recess in the protective cap, and the mounting area.

As said guard ring is detachable from the protective cap, it may be exchanged easily and may also be prepared of higher quality material.

It is also advantageous that said guard ring is insulating, thus preferably allowing the use of a spacer made of conductive material.

The present invention will be explained in greater detail using the attached schematic representations, wherein

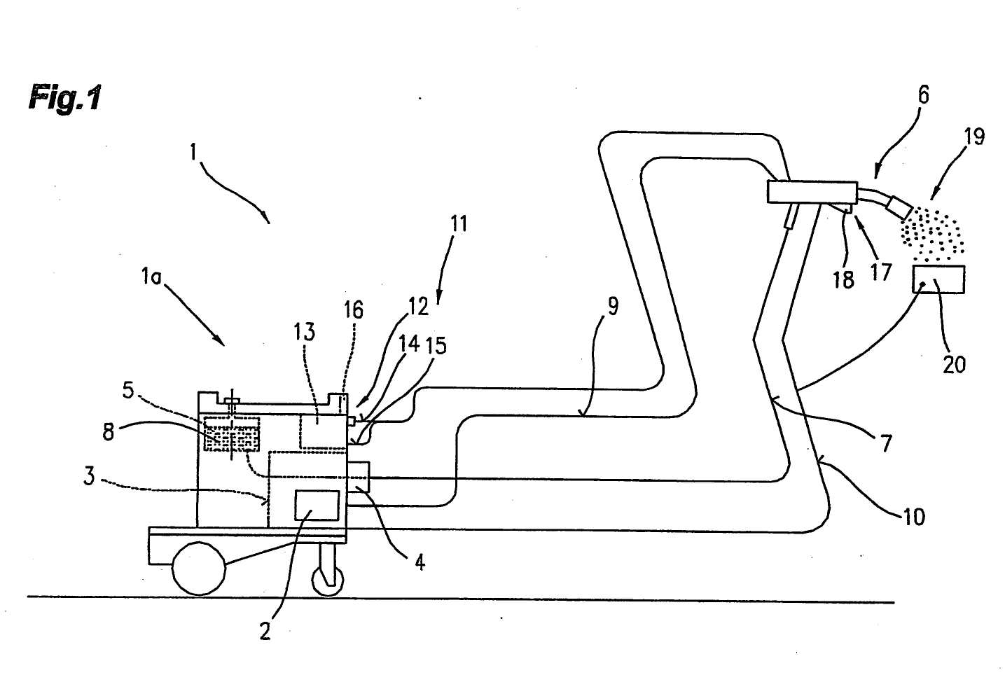

FIG. 1 is an exemplary representation of a vapor cutter;

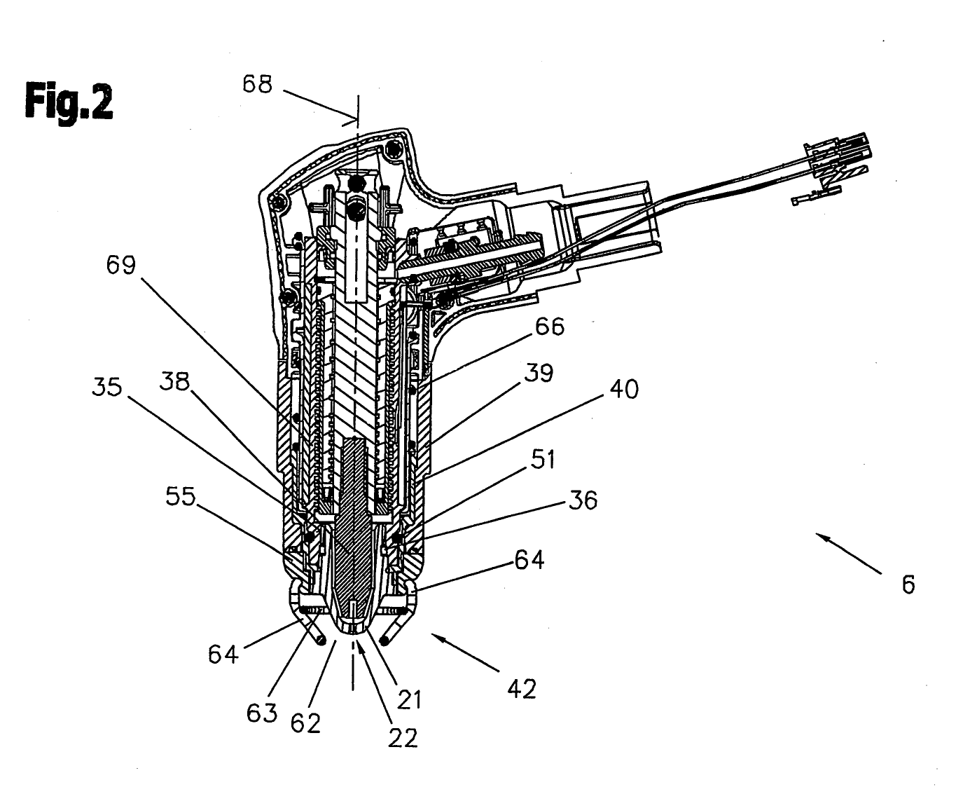

FIG. 2 is an exemplary representation of a cross section of a vapor plasma burner;

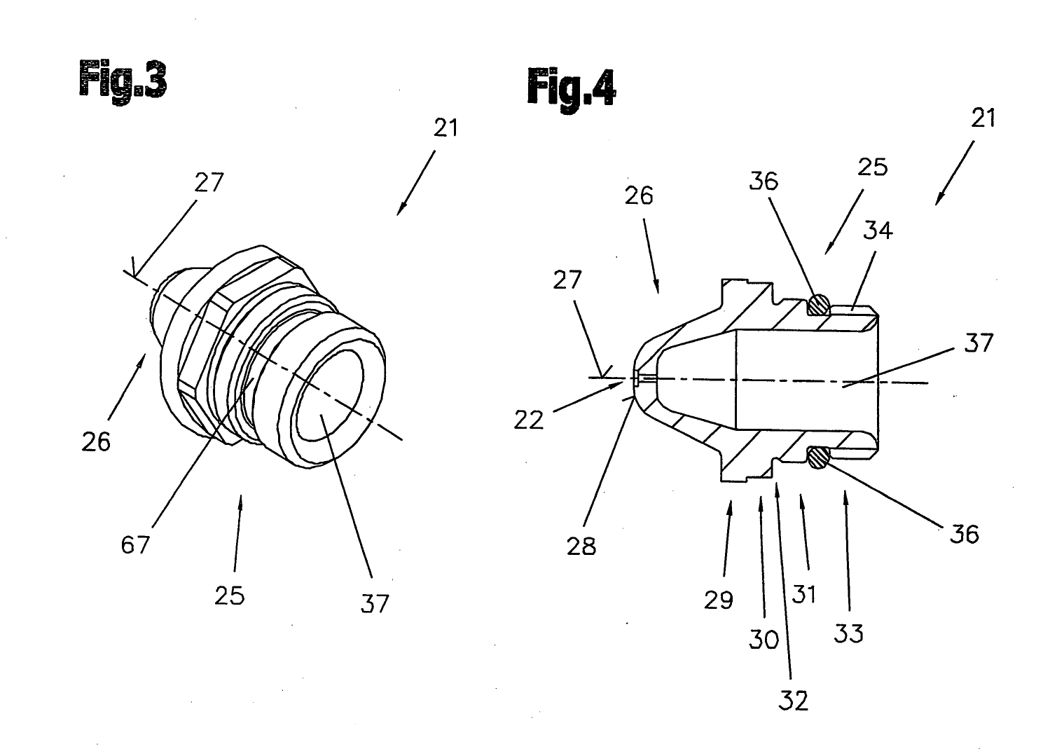

FIG. 3 is an exemplary representation of the nozzle;

FIG. 4 is another exemplary representation of the nozzle;

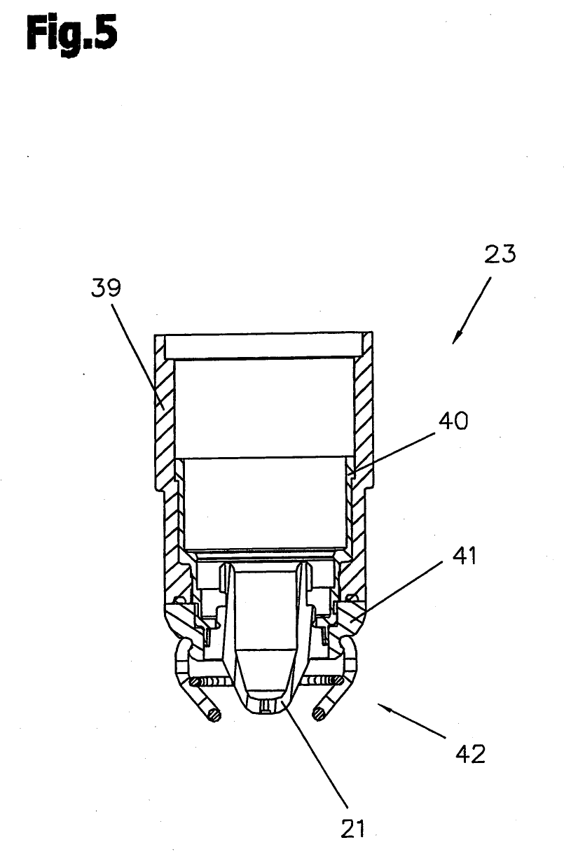

FIG. 5 is an exemplary representation of the protective cap;

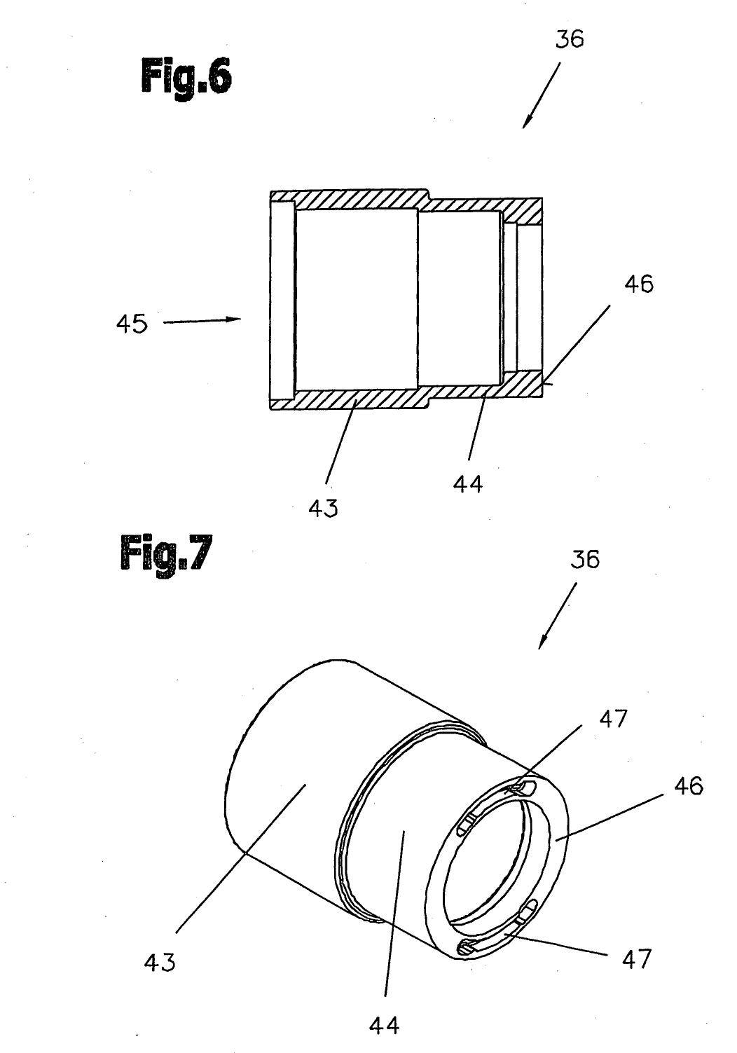

FIG. 6 is an exemplary representation of the screw-on tube;

FIG. 7 is another exemplary representation of the screw-on tube;

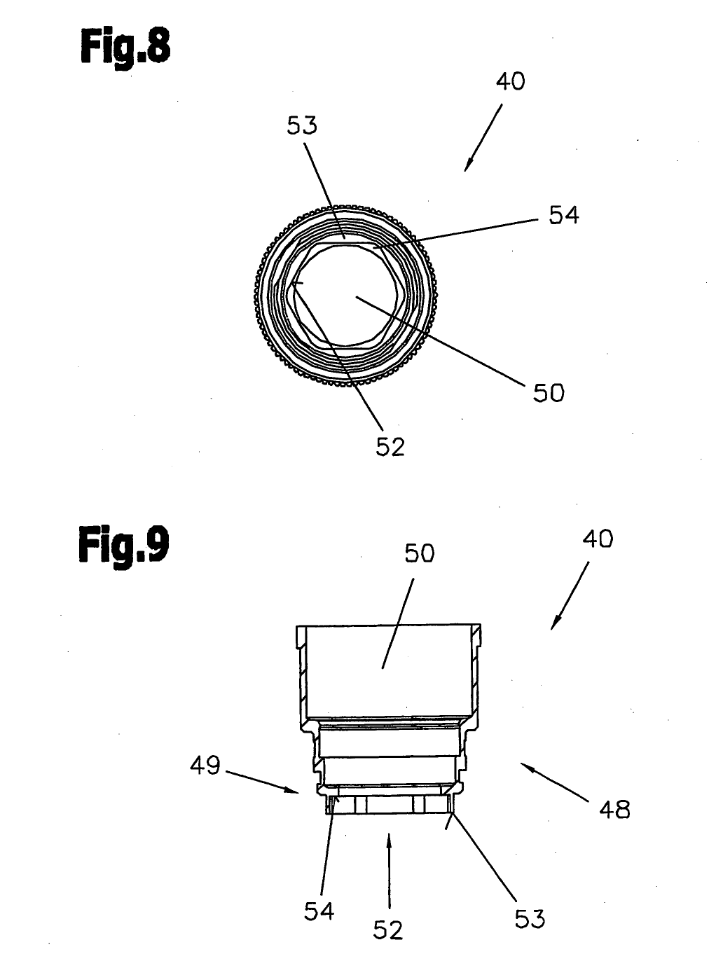

FIG. 8 is an exemplary representation of the receiving element;

FIG. 9 is another exemplary representation of the receiving element;

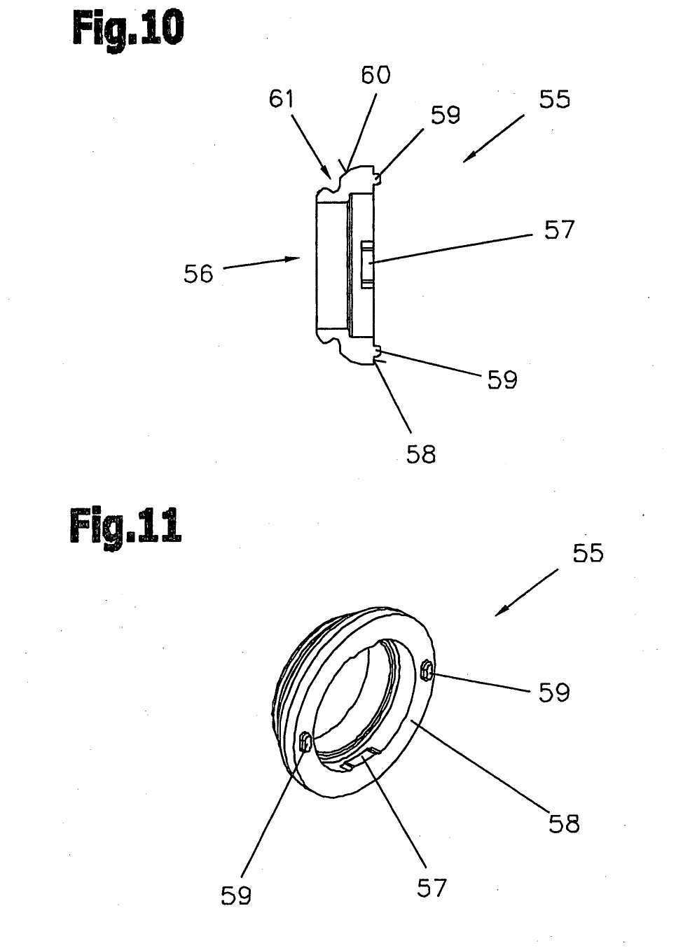

FIG. 10 is an exemplary representation of the guard ring;

FIG. 11 is another exemplary representation of the guard ring;

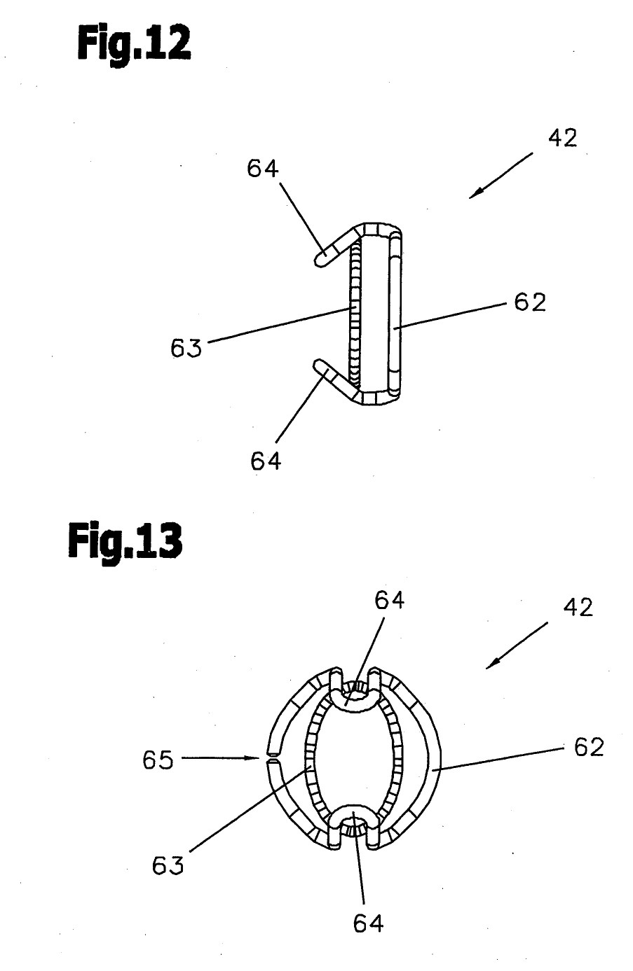

FIG. 12 is an exemplary representation of the spacer; and

FIG. 13 is another exemplary representation of the spacer.

Corresponding parts of the example are given the same numbers.

FIG. 1 shows a vapor cutter 1 having a base 1a for vapor cutting. Said base 1a comprises a current source 2, a control device 3, and a blocking element 4 assigned to said control device 3. Said blocking element 4 is connected to a container 5 and a vapor plasma burner 6 via a feed pipe 7, so that said vapor plasma burner 6 may be supplied with a liquid 8 contained in said container 5. Said vapor plasma burner 6 is supplied with electric energy via cables 9, 10 from said current source 2.

For cooling, said vapor plasma burner 6 is connected to a liquid container 13 via a cooling circuit 11, optionally with a flow control device 12 provided in between. When said burner 6 or said vapor cutter 1 is put into operation, said cooling circuit 11 may be started by said control device 3, thus allowing cooling of said burner 6 via said cooling circuit 11. Said burner 6 is connected to said liquid container 13 via cooling pipes 14, 15 to form said cooling circuit 11.

Moreover, said vapor cutter 1 may be equipped with an input and/or display device 16 allowing setting and display of various parameters or modes of operation of said vapor cutter 1. The parameters set via said input and/or display device 16 are communicated to said control device 3, which correspondingly controls the individual components of said vapor cutter 1.

Furthermore, said vapor plasma burner 6 may be provided with at least one operating element 17, particularly a push-button 18. Via said operating element 17, particularly said push-button 18, the user may communicate from said burner 6 to said control device 3 to start or carry out a vapor cutting process by activating and/or de-activating said push-button 18. Moreover, said input and/or display device 16 may e.g. be used for pre-setting, particularly for pre-defining the material to be cut, the liquid to be used, and e.g. the current and voltage characteristics. Of course, further operating elements may be arranged on said burner 6 for setting one or more operation parameters of said vapor cutter 1 from said burner 6. For this purpose, said operating elements may be connected to said vapor cutter 1, particularly to said control device 3, directly via lines or via a bus system.

When said push-button 18 is actuated, said control device 3 will activate the individual components necessary for the vapor cutting process. For example, first a pump (not shown), said blocking element 4, and said current source 2 are contacted, thus initializing liquid 8 and electric power supply of said burner 6. Subsequently, said control device 3 activates said cooling circuit 11, thus allowing cooling of said burner 6. As said burner 6 is supplied with liquid 8 and energy, particularly current and voltage, said liquid 8 in said burner 6 is transformed into high temperature gas 19, particularly plasma, so that said gas 19 exiting said burner 6 may be used to cut a work piece 20.

Cutting said work piece 20 using said burner 6, which is shown in detail in FIG. 2, additionally requires an arc. Said arc is ignited by said control device 4 or by actuating said push-button 18 and burns between a cathode 35, which is integrated into said burner 6 and is preferably connected to the negative pole of said current source 2, and an anode, which is formed by a nozzle 21 and is connected to the positive pole of said current source 2. If said burner 6 approaches said work piece 20, the positive pole of said current source 2 switches from said nozzle 21 to said work piece 20, said gas 19 drives said arc out through an exit opening 22 in said nozzle 21, and thus said arc burns between said cathode 35 and said work piece 20. Said control device 4 appropriately increases the current for this purpose so that e.g. said work piece 20 may be separated.

During a cutting process, high temperatures and soiling of said nozzle 21 occur, particularly due to the burning arc, and therefore the diameter of the exit opening 22 may become smaller, or its shape may change. In addition, said arc causes wear of said nozzle 21. This may have negative effects on the cutting process. Therefore, said nozzle 21 has to be replaced after a certain number or a certain length of cutting processes.

This may e.g. be effected by screwing out said nozzle 21, which is mounted on said burner 6 via a screw connection, by means of a suitable tool.

According to the present invention, exchange of said nozzle 21 is simplified to such an extent that it may be effected without any tools. For this purpose, the nozzle 21 area of said burner 6 is enveloped by a protective cap 23, which is a component of the housing of said burner 6. Said protective cap 23 has a recess 24 in the area where said protective cap 23 envelops said nozzle 21. Said recess 24 receives said nozzle 21 distortion-proof, so that said nozzle 21 will follow the twisting movement of said protective cap 23. Thus, exchange of said nozzle 21 is preferably effected in such a way that the user of said vapor cutter 1 twists said protective cap 23 with one hand. Thus, said nozzle 21 becomes detached from a base 69 of said burner 6 and may be exchanged. Said nozzle 21 is attached again by twisting. While said nozzle 21 is exchanged, said protective cap 23 remains on said burner 6, i.e. by said twisting movement said nozzle 21 is detached from its mounted position and may subsequently e.g. be ejected from said recess 24 by displacement of said protective cap in a longitudinal direction. However, said protective cap 23 is held or remains on said burner 6 when said nozzle 21 is ejected, so that subsequently a new nozzle 21 is simply inserted or put into said recess 24 and mounted by a twisting movement.

Said protective cap 23 and said nozzle 21 are of such a shape as to allow exchange of said nozzle 21 according to the present invention, as can be seen in FIGS. 3 to 11.

FIGS. 3 and 4 show a nozzle 21. Said nozzle 21 is essentially comprised of two parts, namely an internal part 25 and an external part 26. When the burner 6 is put together, said internal part 25 is inside the protective cap 23, and said external part 26 is outside said protective cap 23. Said external part 26 is of conical shape, i.e. it is configured as a conical area 26, with the tip of said conical external part 26 forming one end of said nozzle 21. Furthermore, the tip of said conical external part 26 is cut essentially at a right angle with respect to the longitudinal axis 27 of said nozzle 21. In the plane 28 resulting therefrom, there is the exit opening 22, the center of which is located on said longitudinal axis 27. Said conical external part 26 of said nozzle concentrates the gas 19 at the exit opening 22, thus allowing cutting.

The internal part 25 is essentially divided into four partial areas. The first partial area 29 is formed by a ring or projection 29 having the largest outer diameter of said nozzle 21. For example, said ring has an outer diameter of 20 mm and is 2 mm thick. Thus, said ring protects the other partial areas of said internal part 25 of said nozzle from soiling as e.g. occurs during cutting. The second partial area 30 or driver area 30 of said internal part 25 is hexagonal in shape and serves to move said nozzle 21 by the twisting movement of said protective cap 23. The dimension of said hexagon is e.g. selected such that its six edges fit with the outer diameter of said ring of said first partial area 29. Consequently, the distance between two opposite edges is e.g. 17 mm. Said hexagon also serves to allow exchange of said nozzle 21 without any tools. The third partial area 31 is shaped as a ring, like said first partial area 29, but it has a smaller outer diameter. Said diameter is selected such that said hexagon covers said ring when looking from said external part 26 towards said internal part 25. For example, said ring has an outer diameter of 16 mm and is 3 mm thick. Where it is adjacent to said hexagon, said ring may also have a longitudinal groove 32. This ring of said partial area 31 preferably serves as a so-called eccentric ring 31 and as a current conductor for the basically positively charged nozzle 21. Using said eccentric ring, said exit opening 22 of said nozzle 21 is exactly centered on said longitudinal axis 68 of said burner 6. Thus, the longitudinal axis 27 of said nozzle 21 and the longitudinal axis 68 of said burner 6 form one axis. The fourth partial area 33 or mounting area 33 of said internal part 25 of said nozzle 21 is shaped as an external thread 34, with the outer diameter of said external thread 34 essentially corresponding to the diameter of the ring of said third partial area 31, i.e. 16 mm. Said external thread 34 primarily serves to secure said nozzle 21 to said burner 6 having a corresponding internal thread 35 on a burner base 69. Second, said external thread also serves as a current conductor to said nozzle 21, but said external thread 34 does not extend along the entire length of said fourth partial area 33 of 7 mm. Thus, a groove 67 of about 2 mm is formed between said fourth partial area 33 and said third partial area 31, which groove receives a sealing ring 36. Said sealing ring 36 has an outer diameter essentially corresponding to the outer diameter of said external thread 34 and said ring in said third partial area 31, i.e. 16 mm. Said sealing ring 36 serves to prevent unintentional leaking of said gas 19 from any other place than said exit opening 22. In addition, said nozzle 21 has a recess 37 or an inner bore 37 connecting said internal part 25 to said external part 26. Where said internal part 25 and said external part 26 meet, said inner bore 37 becomes conical, of course, and is connected to said exit opening 22. Said inner bore 37 also serves to receive said cathode 38, and said inner bore 37 is shaped corresponding to said cathode 38.

When cutting, said nozzle 21 is heated by the arc. This heat is preferably conducted back into said burner 6, where it is used to prepare said gas 19 from said liquid 8. This is referred to as regenerative cooling. For this purpose, said nozzle 21 is prepared of a material that easily conducts heat and electric current, preferably copper. The cross-section of said nozzle 21 also is of such a shape as to allow optimum use of said returned heat.

Said protective cap 23 receiving said nozzle 21 has to be of a certain shape to allow exchange of said nozzle 21 without any tools.

According to FIG. 5, said protective cap 23 is essentially comprised of a screw-on tube 39, a receiving element 40 located inside said screw-on tube 39, and a guard ring 41. For example, said receiving element 40 is pressed into said screw-on tube 39, and said guard ring 41 is detachably secured to said screw-on tube 39. A spacer 42 is arranged on said guard ring 41 to provide a certain distance required for cutting between said nozzle 21 and said work piece 20. The shape of said protective cap 23 is adjusted to the design of said burner 6 so that it may be secured positively to said burner 6 and current is allowed to reach said nozzle 21.

Said screw-on tube 39 is made of electrically insulating material, e.g. ceramics or plastic, thus protecting said electrically conducting receiving element 40. As can be seen in FIGS. 6 and 7, the shape of said screw-on tube 39 corresponds to two tubes 43 and 44 of different diameters, with one tube located inside the other. This results in a recess 45 able to receive said receiving element 40, i.e. shaped corresponding to said receiving element 40. At least one recess 47, preferably two recesses 47, are provided at one front surface 46 of said tube 44. These recesses 47 are used for detachably mounting said guard ring 41.

As shown in FIGS. 8 and 9, said electrically conducting receiving element 40 is e.g. made of a gold-plated metal or brass. Basically, said receiving element 40 may be divided into two parts, preferably into a part 48 inside and a part 49 outside said screw-on tube 39. Said part 48 is essentially comprised of a number of tubes of different diameters. This results in an internal recess 50 which fits positively with said burner 6. Thus, said protective cap 23, which contains said receiving element 40, may be secured to said burner 6 via a spring ring 51. Also, a conducting connection, preferably to the positive pole of said current source 2, is provided via said area 39 of said receiving element 40. Said part 49 receives said nozzle 21, therefore it is shaped essentially corresponding to the internal part 25 of said nozzle 21. Thus, current runs from said receiving element 40 to said nozzle 21 via said part 49.

This means that said part 49 receives the hexagon of said nozzle 21, i.e. the second partial area 30, which means that it has a hexagonal opening 52 (corresponding to said recess 24). In other words, said hexagonal opening 52 corresponds to the hexagon of said second partial area 30 of said nozzle 21, and thus said nozzle 21 is received distortion-proof by said receiving element 40 and current may run to said nozzle 21. Consequently, said first partial area 29 of said internal part 25 of said nozzle 21 rests on the front surface 53 at the end of said part 49 of said receiving element 40. Similarly, said hexagon of said nozzle 21 is adjacent to said receiving element 40, which means that there is a bearing surface 54 behind said hexagonal opening 52, i.e. in the direction of said internal area 48 of said receiving element 40. Said bearing surface 54 results from the fact that said receiving element 40 positively receives said third partial area 31 of said nozzle 21. Due to said front surface 53 and said bearing surface 54, which are covered by said nozzle 21, said protective cap 23 may be secured via said nozzle 21. Moreover, current for cutting may run into said nozzle 21 via said front surface 53 and said bearing surface 54. In other words, current runs into said nozzle 21 via said part 49 located outside said insulating screw-on tube 39. In order to avoid any unintentional contacts or short-circuits, said part 49 is insulated by a guard ring 55.

Said guard ring 55 is preferably connected to said protective cap 23 or said screw-on tube 39 detachably and thus exchangeably. Said guard ring 55 is made of electrically insulating material, e.g. ceramics, and preferably protects said receiving element 40 and said protective cap 23 from heating excessively during a cutting process. For this purpose, said guard ring 55 is configured such that it essentially positively envelops said part 49 of said receiving element 40, as shown in FIGS. 10 and 11. For this purpose, said guard ring 55 has a recess 56 corresponding to said part 49 of said receiving element 40. Said recess 56, which forms the inside of said guard ring 55, also has projections 57, e.g. two. In addition, at least one mounting element 59 is provided at said front surface 58, said mounting elements 59 firmly and detachably connecting said guard ring 55 with said protective cap 23 by a twisting movement. Preferably, two mounting elements 59 are provided on said front surface 58. Said mounting elements 59 snap in the respective recesses 47. This is supported by projections 57, because said receiving element 40 has a corresponding recess. Thus, said guard ring 55 or said mounting elements 59 may only be inserted into said recess 47 if the part of said recess 47 which receives said mounting elements 59, said mounting elements 59, and said projections 55 form one line. Subsequently, said guard ring 55 is secured to said protective cap 23 or said screw-on tube 39 by a twisting movement as in a bayonet coupling. Moreover, said guard ring 55 has a cavity 61 on its rounded outside surface 60. Said cavity 61 serves to secure said spacer 42 protecting said nozzle 21 from unintentional contacts.

Said spacer 42 is essentially comprised of two rings 62 and 63 as shown in FIGS. 12 and 13. Said ring 62 has at least one element 64 defining the distance between said nozzle 21 and said work piece 20. Preferably, said ring 62 has two elements 64, which are e.g. U-shaped. Thus, said nozzle 21 is protected from unintentional contacts and is at a defined distance to said work piece 20. Said ring 62 serves to secure said spacer 42 to said cavity 61 of said guard ring 55, and therefore said ring 62 is expandable by means of said opening 65. Said second ring 63 is attached to said elements 64 and provides the necessary stability to said spacer 42. This aim is reached by said ring 63 enveloping said nozzle 21 in said conical part, i.e. in said external part 26, e.g. in the central region of said external part 26 of said nozzle 21. For this purpose, said ring 63 is secured to said elements 64. It is also possible for said rings 62 and 63 to be of elliptical shape.

Thus, a cutting process may be carried out using said vapor cutter 1, wherein said protective cap 23 and said nozzle 21 must be firmly connected to said burner 6 to ensure current conduction and to make sure that said gas 19 only exits through said exit opening 22 of said nozzle 21.

According to the present invention, such firm connection is provided by said nozzle 21 being inserted into said receiving element 40 of said protective cap 23. Subsequently, said protective cap 23 is attached to said burner 6, and said cap is held in place on said burner 6 autonomously via a spring 66 or a spring element 66 and said spring ring 51 while being displaceable in the direction of said longitudinal axis 27. Said protective cap 23 may be removed from said burner 6 by a jerky movement. Of course, it is also possible for said protective cap 23 to be already mounted on said burner 6 when receiving said nozzle 21. When said protective cap 23 is twisted, said nozzle 21 will follow via said distortion-proof connection via said hexagon of said nozzle 21. Consequently, said external thread 34 of said fourth partial area 33 of said nozzle 21 will connect accordingly to said internal thread 35 inside said burner 6. Thus, said protective cap 23 is secured by said nozzle 21, and a firm connection is provided between said nozzle 21 or said protective cap 23 and said burner 6. Advantageously, said twisting movement is carried out by hand, not requiring any tools.

Also, no tools are necessary for exchanging said nozzle 21. Similar to mounting said nozzle 21, said protective cap 23 is screwed or twisted off, thus detaching said nozzle 21 from said internal thread 35 inside said burner 6. Said twisting movement of said protective cap 23 is supported by said spring 66, which is provided inside said burner 6 and acts correspondingly on said receiving element 40. Said protective cap 23 is held on said burner 6 via a spring ring 51, so that the power of said spring 66 can not detach said protective cap 23 from said burner 6 uncontrolled. When said protective cap 23 is in this position, said nozzle 21 is already detached from said internal thread 35 of said burner 6, so that twisting said protective cap 23 only results in so-called idling. Moreover, when said protective cap 23 is in this position, said nozzle 21 will fall out of said protective cap 23 due to the action of gravity. Said spacer 42 is mounted in such a way that it is detached from said protective cap 23 together with said nozzle 21, so as not to impede exchange of said nozzle 21. It is also possible for said spacer 42 to be configured as part of said nozzle 21. If said nozzle 21 is exchanged immediately after cutting, said nozzle 21 will be hot. This may result in a slight expansion of said nozzle 21, so that it does not automatically detach from said protective cap 23. In this case, said nozzle 21 may be detached from said protective cap 23 by a jerky backward movement of said protective cap. Due to said spring 66, said protective cap 23 is then moved forward again for mounting a new nozzle 21 on said burner 6.

Of course, said protective cap 23, said nozzle 21, and said spacer 42 shown in FIGS. 2 to 13 are but one embodiment. For example, it is possible to configure said conical external part 26 of said nozzle 21 such that it takes over the function of said first partial area 29 of said internal part 25 of said nozzle 21, i.e. such that it protects from soiling. Moreover, it is also possible, of course, that the preferred diameter of said exit opening 22 of said nozzle 21 of 0.7 mm is adjusted corresponding to the application. Furthermore, it is also possible that said second partial area 30 of said nozzle 21 is an octagon or a circle having one or more protruding bars which are received distortion-proof by said recess 52 of said receiving element 40.

1: A device for exchanging a nozzle (21) of a vapor plasma burner (6) comprising a housing, a cathode (38) connected to a cathode support, and an anode, configured as a nozzle (21) and having an exit opening (22), wherein said nozzle (21) can be connected to a base (69) of said vapor plasma burner (6), wherein a preferably insulating protective cap (23) is disposed in the area of the exit opening (22) of said nozzle (21), said protective cap (23) being detachable via a spring element (66) and being rotationally secured to said base (69) of said vapor plasma burner (6), and said protective cap (23) has at its front a recess (24) corresponding to said nozzle (21) into which said nozzle (21) may be inserted, and in that said nozzle (21) may be detached from or secured to said base (69) without the use of auxiliary means by displacing said protective cap (23).

2: A device according to claim 1, wherein said nozzle (21) is detachable from said vapor plasma burner (6) by a twisting movement by said protective cap (23).

3: A device according to claim 1, wherein after detaching said nozzle (21) said protective cap (23) still remains on said burner (6) and is displaceable.

4: A device according to claim 1, wherein said protective cap (23) is secured to said vapor plasma burner (6) and remains thereon when said nozzle (21) is exchanged.

5: A device according to claim 1, wherein said nozzle (21) may be secured to said vapor plasma burner (6) by a twisting movement by said protective cap (23), and said protective cap (23) may be simultaneously secured to said base (69) via said nozzle (21).

6: A device according to claim 2, wherein said twisting movement may be effected by the user of said vapor plasma burner (6) using only one hand.

7: A device according to claim 2, wherein said nozzle (21) is detached from said protective cap (23), i.e. thrown out of the recess (24) of said protective cap (23), by a supportive, jerky backwards movement of said protective cap (23) after said nozzle (21) has been detached from said base (69) by said twisting movement by said protective cap (23).

8: A device according to claim 1, wherein said spring element (66) positions said protective cap (23) on said base (69) in such a way as to allow reception of said nozzle (21).

9: A device according to claim 1, wherein said recess (24) of said protective cap (23) is of such a shape, e.g. hexagonal, that said nozzle (21) may be driven along without being distorted.

10: A nozzle for a vapor plasma burner (6), comprising a preferably conical area (26) having an exit opening (22), a recess (37) connected to said exit opening (22), and a mounting area (33) for attachment to burner (6), particularly via an external thread (34) also providing current transfer to said nozzle (21), wherein a driver area (30) is arranged between said mounting area (33) and said preferably conical area (26), said driver area (30) being of such a shape that said nozzle (21) is received positively and distortion-proof in a protective cap (23) of said plasma vapor burner (6) to secure said nozzle (21) to said vapor plasma burner (6).

11: A nozzle according to claim 10, wherein said driver area (30) is hexagonal in shape and preferably has a projection (29) adjacent to said preferably conical area (26).

12: A nozzle according to claim 10, wherein said driver area (30) is octagonal in shape and preferably has a projection (29) adjacent to said preferably conical area (26).

13: A nozzle according to claim 10, wherein said mounting area (33) has a sealing ring (36) to keep gas (19) from leaking.

14: A nozzle according to claim 10, wherein an eccentric ring (31) is provided between said driver area (30) and said sealing ring (36).

15: A nozzle according to claim 10, wherein said nozzle (21) is configured for use with the device for exchanging a nozzle (21) of a vapor plasma burner (6).

16: A guard ring for a vapor plasma burner (6) protecting the vapor plasma burner (6) components from thermal influences and insulating current-carrying components, wherein at least one mounting device (59) for detachable mounting on a protective cap (23) is arranged on a front surface (58), and a recess (56) is provided which is configured to receive and envelop a nozzle (21) during mounting.

17: A guard ring according to claim 16, wherein at least one elevation (57) is provided on its inside.

18: A guard ring according to claim 16, wherein two elevations (57) are provided.

19: A guard ring according to claim 16, wherein particularly two mounting devices (59) are provided.

20: A guard ring according to claim 16, wherein recesses (47) are provided to receive said mounting devices (59).

21: A guard ring according to claim 20, wherein said mounting devices (59) snap into said recesses (47) of said protective cap (23) by a twisting movement.

22: A guard ring according to claim 16, wherein a groove or cavity (61) is provided on its outside (60) for mounting a spacer (42).
